(19) United States
(12) Patent Application Publication
(10) Pub. No.: US 2015/0263351 A1
(43) Pub. Date: Sep. 17, 2015

(54) ANODE FOR DIRECT CARBON FUEL CELL AND DIRECT CARBON FUEL CELL INCLUDING THE SAME

(71) Applicant: PUSAN NATIONAL UNIVERSITY INDUSTRY-UNIVERSITY COOPERATION FOUNDATION, Geumjeong-gu Busan (KR)

(72) Inventors: Dong-Geun Lee, Busan (KR); Cheng-Guo Li, Busan (KR)

(73) Assignee: PUSAN NATIONAL UNIVERSITY INDUSTRY-UNIVERSITY COOPERATION FOUNDATION, Busan (KR)

(21) Appl. No.: 14/435,170

(22) PCT Filed: Jul. 24, 2013
(86) PCT No.: PCT/KR2013/006630

§ 371 Date: Apr. 12, 2015

(30) Foreign Application Priority Data
Aug. 31, 2012 (KR) 10-2012-0096723

(51) Int. Cl. H01M 4/86; H01M 4/90; H01M 8/14

(52) U.S. Cl. CPC H01M 4/8605; H01M 4/8657; H01M 8/146; H01M 8/145; H01M 4/9025; H01M 2008/147

(57) ABSTRACT

The present invention relates to an anode for a direct carbon fuel cell based on a molten carbonate or molten hydroxide electrolyte. The anode includes a porous metal. The present invention also relates to a direct carbon fuel cell including the anode. The direct carbon fuel cell includes the anode, a cathode, and an electrolyte. According to the present invention, the use of the porous metal can maximize the surface area of the anode, fuel particles are infiltrated into the porous metal to increase the contact area with the anode and the fuel, and the surface of the porous metal is coated with an oxide to enhance the wettability of the anode. Therefore, the contact at the triple phase boundaries is maximized and the problem of discontinuous fuel supply can be solved, thereby greatly improving the efficiency of the fuel cell.

### TECHNICAL FIELD

The present invention relates to an anode that can be used to improve the performance of a direct carbon fuel cell. The present invention also relates to a direct carbon fuel cell including the anode.

### BACKGROUND ART

Fuel cells have received attention as promising new energy technologies due to their advantages of high efficiency and pollution-free operation. Research has been conducted on various types of fuel cells, including polymer electrolyte membrane fuel cells (PEMFCs), solid oxide fuel cells (SOFCs), and direct methanol fuel cells (DMFCs). Such fuel cells are based on the electrochemical reactions of hydrogen as a fuel and oxygen in air for direct electricity production. In contrast, direct carbon fuel cells (DCFCs) are new conceptional fuel cells that directly use carbon and coal as fuels. The energy conversion efficiency of fuel cells using hydrogen as a fuel is limited to only 45% while that of direct carbon fuel cells amounts to at least 70%. For this reason, extensive research has been made recently on direct carbon fuel cells as highly efficient energy conversion devices.

DCFCs under development can be broadly classified by the kind of electrolyte they employ. DCFCs employing molten carbonate, molten hydroxide or solid oxide electrolytes have been investigated so far. Much research on DCFCs has been led by research institutes and companies in the United States. In recent years, China has actively participated in DCFC technology development.

Specifically, DCFCs employing molten carbonates, which are also employed as electrolytes in molten carbonate fuel cells (MCFCs), use fuels supplied in the form of powders of various carbon sources, such as amorphous carbon, pulverized coal, and graphite. The fuels may be slurries in the form of mixtures of the carbon sources and electrolytes. In most cases, the DCFCs directly use carbon rods as anodes. Button cell type DCFCs based on solid oxide fuel cells (SOFCs) employ solid electrolytes (YSZ, GDC) and mostly use molded products of carbon powders as anodes. In other cases, Ni—Cr alloys are used as the electrode materials and carbon powders are scattered thereon to allow electrochemical reactions to proceed.

However, DCFCs developed hitherto suffer from discontinuous fuel supply and have the limitation of poor activity resulting from the formation of limited triple phase boundaries. The triple phase boundaries refer to junctions where an electrode, a fuel, and an electrolyte meet.

It is, therefore, an object of the present invention to provide an anode for a direct carbon fuel cell (DCFC) that can maximize the area of triple phase boundary directly affecting DCFC efficiency.

It is another object of the present invention to provide a direct carbon fuel cell that includes the anode capable of maximizing the area of triple phase boundary and can provide a solution to the problem of discontinuous fuel supply.

### Technical Solution

One aspect of the present invention provides an anode for a direct carbon fuel cell based on a molten carbonate or molten hydroxide electrolyte wherein the anode includes a porous metal to maximize the area of triple phase boundary.

Preferably, the porous metal is selected from nickel, chromium, aluminum, copper, and alloys thereof.

In the present invention, the porous metal is preferably coated with an oxide. More preferably, the oxide is a metal oxide selected from CeO₂, Al₂O₃, MgO, PbO, and Gd₂O₃. The contact angle between the molten carbonate or molten hydroxide electrolyte and the oxide-coated porous metal is from 0° to 40°.

A further aspect of the present invention provides a direct carbon fuel cell including a cathode, an anode including a porous metal, and an electrolyte.

Preferably, the electrolyte is a molten carbonate or molten hydroxide. More preferably, the molten carbonate is Li₂CO₃, K₂CO₃, NaCO₃, MgCO₃ or a mixed salt thereof. Preferably, the molten hydroxide is LiOH, KOH, NaOH or a mixed salt thereof and the melting point of the mixed salt is from 450 to 650° C.

Preferably, the porous metal is infiltrated with solid-state carbon particles to allow continuous supply of the carbon particles. More preferably, the carbon particles are selected from particles of coal, graphite, carbon black, amorphous carbon powders, and mixtures thereof. The porous metal is infiltrated with a mixture of the carbon particles and the electrolyte to allow continuous supply of the carbon particles.

### Advantageous Effects

As described above, the use of a porous metal in the anode of the present invention is effective in increasing the contact area of the electrode with a fuel and an electrolyte as much as possible. In addition, the surface coating of the porous metal with an oxide minimizes the contact angle between the electrolyte and the electrode to enhance the wettability of the electrode, thus being effective in increasing the affinity of the electrode for the electrolyte. In the direct carbon fuel cell of the present invention, fuel particles are infiltrated into the porous metal. Therefore, the contact area between the fuel and the electrode is maximized and the problem of discontinuous fuel supply can be solved.

### DESCRIPTION OF DRAWINGS

FIG. 1 shows a schematic diagram of a DCFC and the contact surface between a nickel electrode according to one embodiment of the present invention and a fuel; (a) a power supply, b) a ceramic tube, c) a matrix, d) an electrolyte, e) an anode current collector, f) an anode, g) a cathode, h) a cathode current collector, i) a temperature control unit, j) a software & MFC controller, k) an MFC, l) a humidifier, m) a line heater, n) a real temperature, o) gases (O₂, CO₂, Ar), p) a gas line to the anode (O₂, CO₂→CO₂→Ar), q) a gas line to the cathode (O₂→CO₂→O₂, CO₂)).

FIG. 2 schematically shows a filtration process for infiltrating carbon particles into an electrode according to one embodiment of the present invention.

FIG. 3 shows electron microscopy images of a porous nickel electrode (a) before and (b) after infiltration with fuel particles.

FIG. 4 shows the results of SEM and EDS mapping analyses for the surfaces of porous nickel electrodes.

FIG. 5 shows the contact angles of nickel plates for an electrolyte.

FIG. 6 shows electrochemical power curves of porous nickel electrodes.

### MODE FOR INVENTION

The present invention will now be described in detail.

The present invention is intended to maximize the area of triple phase boundary directly affecting the efficiency of a direct carbon fuel cell. Specifically, the present invention is intended to provide a porous metal electrode with large surface area as an anode whose contact area with a fuel and an electrolyte is increased as much as possible.

In one aspect, the present invention is directed to an anode for a direct carbon fuel cell based on a molten carbonate or molten hydroxide electrolyte wherein the anode includes a porous metal.

Preferably, the porous metal is selected from nickel, chromium, aluminum, copper, and alloys thereof.

Preferably, the porous metal is preferably coated with an oxide. More preferably, the oxide is a metal oxide selected from CeO₂, Al₂O₃, MgO, PbO, and Gd₂O₃. This oxide coating enhances the wettability of the electrode. As a result, the adsorption of the electrolyte to the electrode is improved, resulting in high efficiency of the fuel cell. Preferably, the contact angle between the molten carbonate or molten hydroxide electrolyte and the oxide-coated porous metal is from 0° to 40°.

In one embodiment of the present invention, the oxide is CeO₂. In the Examples Section that follows, it was confirmed that the contact angle was 95° when CeO₂ was coated at a concentration of 0.01 mol % and 20.4° at a concentration of 0.1 mol %. Accordingly, the oxide concentration needs to be controlled such that the wettability of the electrode is enhanced. The concentration of the oxide can be adjusted by varying the concentrations of raw materials for the oxide. The contact angle between the electrolyte and the porous metal of the direct carbon fuel cell is limited to less than 40°. Due to this limitation, the oxide coating can function as a barrier to the migration of electrons created as a result of electrochemical reactions to prevent the power generation efficiency of the fuel cell from deteriorating.

In a further aspect, the present invention is directed to a direct carbon fuel cell including a cathode, the anode including the porous metal, and an electrolyte.

Preferably, the electrolyte is a molten carbonate or molten hydroxide. More preferably, the molten carbonate is Li₂CO₃, K₂CO₃, NaCO₃, MgCO₃ or a mixed salt thereof. Preferably, the molten hydroxide is LiOH, KOH, NaOH or a mixed salt thereof and the melting point of the mixed salt is from 450 to 650° C.

Preferably, the porous metal is infiltrated with solid-state carbon particles to allow continuous supply of the carbon particles. The infiltration of the solid-state carbon particles as fuel particles increases the contact area between the fuel and the electrode, leading to a significant improvement in the efficiency of the fuel cell, and provides a solution to the problem of discontinuous fuel supply. More preferably, the carbon particles are selected from particles of coal, graphite, carbon black, amorphous carbon powders, and mixtures thereof. The porous metal is infiltrated with a mixture of the carbon particles and the electrolyte to allow continuous supply of the carbon particles.

The present invention will be explained in more detail with reference to the following examples. However, these examples are provided for illustrative purposes only and the scope of the invention is not limited thereto.

### EXAMPLES 1-3>

(1) Materials and Methods

DCFC cells were fabricated using a porous nickel electrode (INCOFOAM®, porosity 97%) as an anode, a NiO electrode supported by the Korea Institute of Science and Technology (KIST) as a cathode, and a molten carbonate electrolyte. Carbon black (Alfa aesar, Purity 99.9%) was used as a carbon fuel. The specifications of the components of the fuel cells are shown in Table 1.

TABLE 1

| Component | Specification | |
|---|---|---|
| Anode | Material/thickness/diameter/current collector | Ni/0.2 mm/1.7 cm/Pt mesh |
| Cathode | Material/thickness/diameter/current collector | NiO/0.65 mm/1.9 cm/Pt mesh |
| Matrix | Material/thickness/diameter | LiAlO₂/0.33 mm/2.85 cm |
| Electrolyte | Material | 62 mol % Li₂CO₃-38% mol % K₂CO₃ |

(2) Fabrication of Direct Carbon Fuel Cells

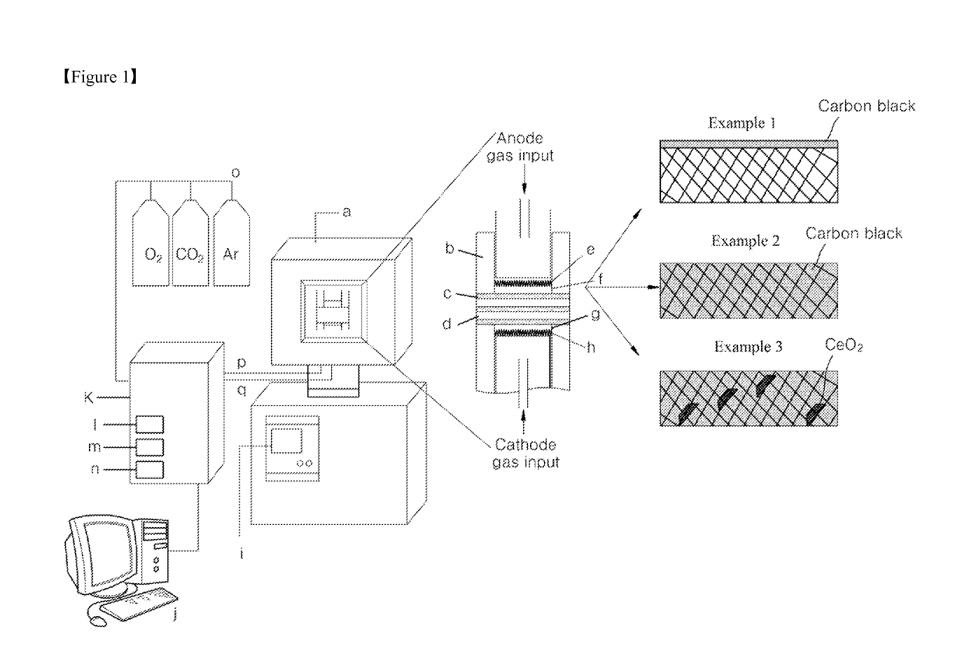

As shown in FIG. 1, the cathode, the matrix, and the electrolyte were laid in this order, and the anode as the outermost component was laid thereon. A current collector made of a Pt mesh having the lowest resistance was arranged outside each electrode to measure the performance of the fuel cells. A molded product of a carbon powder was placed on the porous nickel electrode (Example 1), a carbon powder was infiltrated into the electrode (Example 2), and CeO₂ was coated on the electrode of Example 2 (Example 3). The carbon powder was flowable in the electrode of Example 2 and the coated electrode of Example 3.

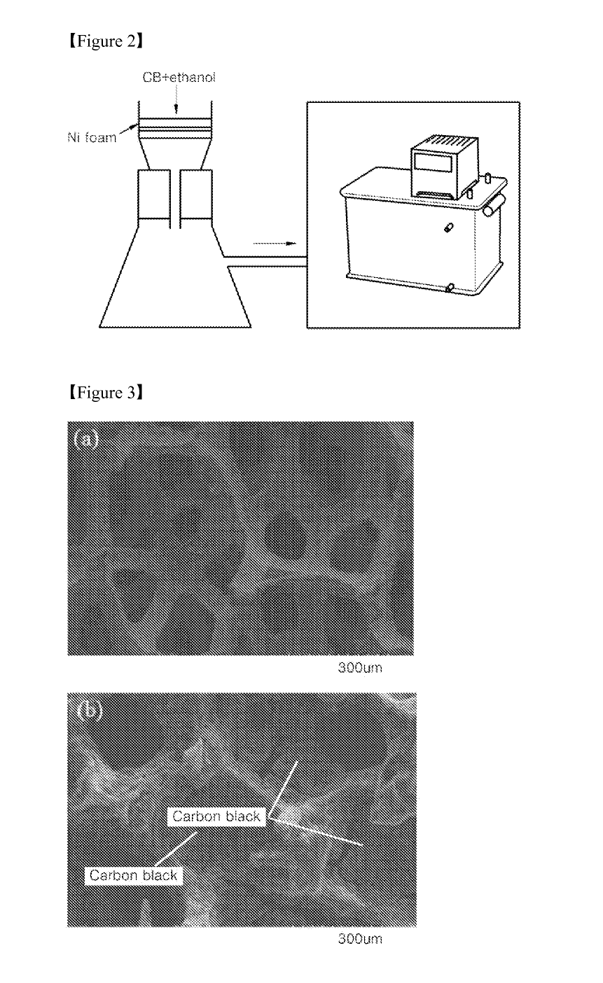

Specifically, in Example 2, the carbon powder was infiltrated into the electrode by the following filtration process (FIG. 2).

First, the porous nickel electrode was mounted on the filter. A mixture of 0.5 g of carbon black and 50 ml of ethanol was stirred for 1 h. The suspension stability of the mixture was improved using a high-power ultrasonic mixer. Next, the mixed solution was sampled with a pipette. The sample was dropped onto the porous nickel electrode, and at the same time, the vacuum pump was operated such that a vacuum was created downstream of the filter to allow the mixed solution to pass through the filter. As a result of the filtration, the carbon particles were attached to the electrode and the ethanol penetrated through the filter. This procedure was repeated until the solution was used up. Finally, the carbon-infiltrated electrode was dried at room temperature for 24 h.

In Example 3, the anode was surface coated with CeO₂ by a sol-gel process. Specifically, 250 mg of (CeCl₃.7H₂O, Sigma Aldrich) and 100 mg of citric acid were mixed with ethanol and the mixture was stirred for 30 min to achieve complete dissolution. Subsequently, the porous electrode or plate was dipped 5-10 times in the solution, dried at 60° C. for 30 min, heated to 500° C. at a rate of 20° C./min in an electric furnace, and heated for 10 min while maintaining at the same temperature, affording sol-gel prepared CeO₂ particles on the electrode surface.

(3) Evaluation of Performance of the Fuel Cells

After the fuel cell components were put in a ceramic tube and securely fixed to each other, they were allowed to drive. Since the cell components were only physically in close contact with each other, they were thermally treated by slow heating. A DCFC is a high temperature fuel cell whose temperature rises to 700° C. When gases at room temperature enter the fuel cell from the outside, the large temperature difference may cause many problems, such as cell damage and electrolyte coagulation. To prevent such problems, a line heater is used to supply hot gases. When an electric furnace reaches a temperature of 350-400° C., a predetermined amount of CO₂ gas is supplied to each electrode. In this temperature zone, the electrolyte begins to melt and is lost little by little. The CO₂ gas entering the electrode lowers the operating temperature to prevent the electrolyte from evaporating and being lost to some extent. The flow rates of gases entering the cell vary depending on the cell size. In the present invention, the flow rates of entering gases were determined taking into consideration that the area of the cell at the anode side was 2.67 cm². The gases were allowed to enter the anode and the cathode at flow rates of 65 ml/min and 50 ml/min, respectively. The flow rates of the gases were kept until the temperature reached 650° C. From the measurement zone, O₂ gas was supplied at a rate of 30 ml/min for the reduction reaction at the cathode and CO₂ gas was supplied at a rate of 30 ml/min to prevent loss of the electrolyte. In this state, such factors as OCV, I-V, and power were measured to evaluate the performance of the anode.

The results will be explained with reference to the drawings.

FIG. 3 shows whether the fuel particles were infiltrated into the porous anode. In FIG. 3, (a) and (b) are images showing the porous nickel electrode before and after infiltration of the carbon black particles, respectively. The images confirm uniform distribution of the infiltrated carbon black particles in the electrode. It was also confirmed that the carbon was not attached to the filter disposed at the lower end of the electrode, demonstrating infiltration of the carbon particles as fuel particles into the porous electrode. These results can lead to conclusion that uniform infiltration of the fuel particles into the porous nickel electrode increases the contact area between the electrode and the fuel.

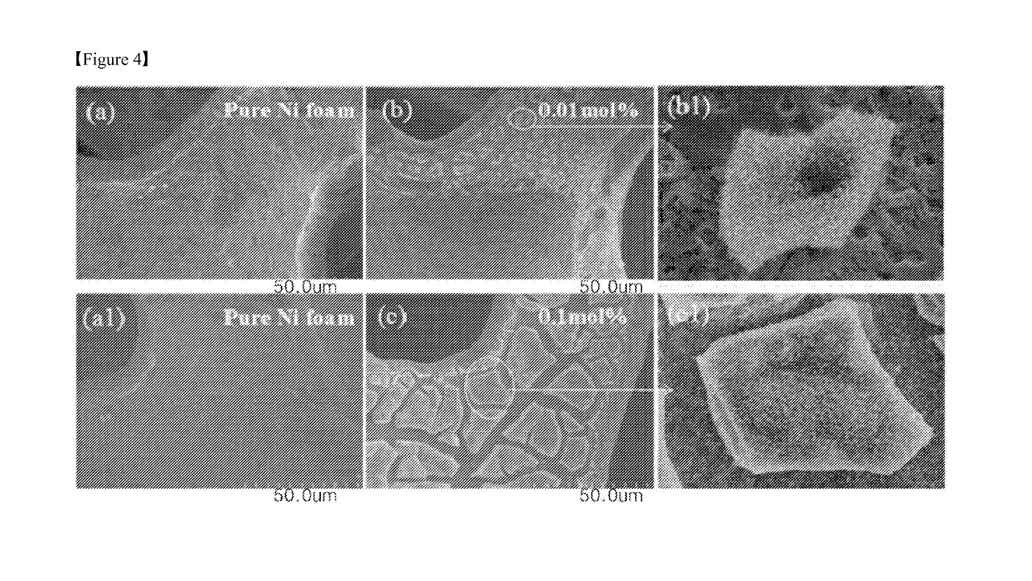

The oxide (CeO₂) particles coated on the surface of the porous nickel electrodes were characterized in terms of distribution and shape by SEM and EDS mapping. The results are shown in FIG. 4. In FIG. 4, (a) shows the pure non-coated porous nickel electrode, (b) and (c) show the porous nickel electrodes coated with 0.01 mol % and 0.1 mol % of CeO₂, respectively, and (b1) and (c1) shows the results of EDS mapping. For 0.01 mol % of CeO₂, only a portion of the surface of the electrode was coated with the oxide. EDS mapping revealed that the electrode was coated with the CeO₂ particles, as marked by the bright (white) dots in (b1) of FIG. 4. For 0.1 mol % of CeO₂, a thicker and wider CeO₂ coating was formed over the entire surface of the electrode. For 1.0 mol % of CeO₂, a very thick CeO₂ coating was formed over the entire surface of the nickel electrode.

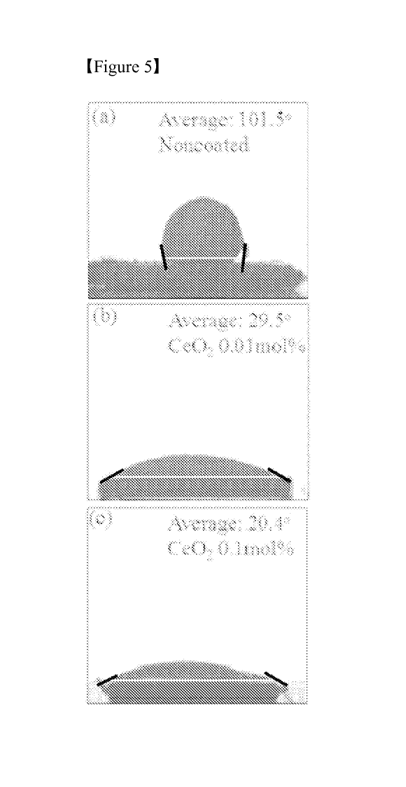

Changes in the affinity of the electrode for the electrolyte or the wettability of the electrode with the electrolyte before and after CeO₂ coating were observed through contact angle measurement. The results are shown in FIG. 5. Nickel plates were used instead of the porous nickel electrodes whose contact angles were impossible to measure. The nickel plates were surface coated in the same manner as the porous nickel electrodes, and then the electrolyte was directly melted and cooled thereon. The contact angles between the coated nickel plates and the electrolyte and are shown in FIG. 5. In FIG. 5, (a) shows the contact angle (101°) of the non-coated nickel plate. The large contact angle indicates poor affinity of the nickel electrode for the electrolyte. In FIG. 5, (b) and (c) show the contact angles (29.5° and 20.4°) of the nickel plates coated with 0.01 and 0.1 mol % of CeO₂, respectively. The greatly reduced contact angles indicate effective modification of the nickel plates with CeO₂. In conclusion, the oxide coating enhanced the wettability of the electrodes, leading to an increase in the affinity of the electrodes for the electrolyte. The increased affinity is believed to ensure sufficient contact between the electrodes and the electrolyte at the triple phase boundaries, achieving higher fuel cell efficiency.

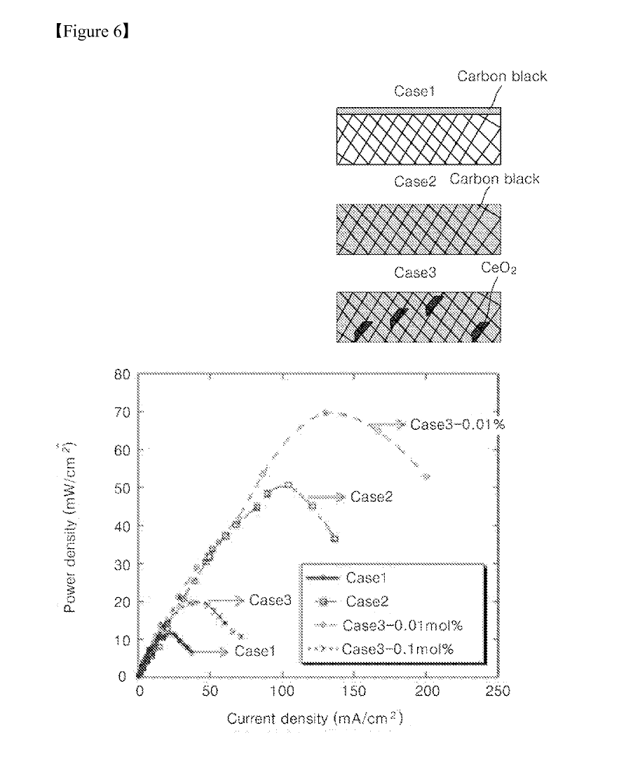

FIG. 6 shows electrochemical power curves of the porous electrodes illustrating the increasing effect of the electrodes on contact area and the enhancing effect of the coatings on wettability. In FIG. 6, Case 1 shows a structure (corresponding to Example 1) in which carbon black was spread on the surface of the nickel electrode, Case 2 shows a structure (corresponding to Example 2) in which carbon black was infiltrated into the porous nickel electrode to increase the contact area between the electrode and the fuel, and Case 3 shows structures (corresponding to Example 3) in which the electrodes were surface coated with 0.01 mol % and 0.1 mol % of CeO₂. The current density and power density of the porous electrode coated with 0.01 mol % of CeO₂ were increased by about 40% compared to those of the non-coated electrode. This oxide coating is believed to enhance the wettability of the electrode with the electrolyte, activating a larger contact area of triple phase boundary. In contrast, the electrode coated with 0.1 mol % of CeO₂ had a lower power density than the non-coated electrode as well as the electrode coated with 0.01 mol % of CeO₂. From these results, it can be inferred that the oxide coating with rather low conductivity formed between the fuel and the electrode functions as a barrier to the migration of electrons created as a result of electrochemical reactions to deteriorate the power generation efficiency of the fuel cell.

From the above experimental results, it can be concluded that the efficiency of the fuel cell can be improved by the use of the porous electrode with large surface area, the infiltration of the fuel particles to increase the contact area with the porous electrode, and the coating of the oxide on the electrode surface to enhance the wettability of the electrode. Particularly, the enhanced wettability of the electrode leads to an increase in the affinity of the electrode for the electrolyte, ensuing sufficient contact between the electrode and the electrolyte at the triple phase boundaries. That is, the anode of the present invention can maximize the area of triple phase boundary directly affecting DCFC efficiency. Therefore, the use of the anode is expected to greatly improve the efficiency of the fuel cell according to the present invention.

1. An anode for a direct carbon fuel cell based on a molten carbonate or molten hydroxide electrolyte wherein the anode comprises a porous metal.

2. The anode according to claim 1, wherein the porous metal is selected from nickel, chromium, aluminum, copper, and alloys thereof.

3. The anode according to claim 1, wherein the porous metal is coated with an oxide.

4. The anode according to claim 3, wherein the oxide is a metal oxide selected from CeO2, Al2O3, MgO, PbO, and Gd2O3.

5. The anode according to claim 3, wherein the contact angle between the molten carbonate or molten hydroxide electrolyte and the oxide-coated porous metal is from 0° to 40°.

6. A direct carbon fuel cell comprising a cathode, an anode comprising a porous metal, and an electrolyte.

7. The direct carbon fuel cell according to claim 6, wherein the anode is the anode according to claim 1.

8. The direct carbon fuel cell according to claim 6, wherein the electrolyte is a molten carbonate or molten hydroxide.

9. The direct carbon fuel cell according to claim 8, wherein the molten carbonate is Li2CO3, K2CO3, NaCO3, MgCO3 or a mixed salt thereof.

10. The direct carbon fuel cell according to claim 8, wherein the molten hydroxide is LiOH, KOH, NaOH or a mixed salt thereof and the melting point of the mixed salt is from 450 to 650° C.

11. The direct carbon fuel cell according to claim 6, wherein the porous metal is infiltrated with solid-state carbon particles to allow continuous supply of the carbon particles.

12. The direct carbon fuel cell according to claim 11, wherein the carbon particles are selected from particles of coal, graphite, carbon black, amorphous carbon powders, and mixtures thereof.

13. The direct carbon fuel cell according to claim 11, wherein the porous metal is infiltrated with a mixture of the carbon particles and the electrolyte.

14. The direct carbon fuel cell according to claim 6, wherein the anode is the anode according to claim 2.

15. The direct carbon fuel cell according to claim 6, wherein the anode is the anode according to claim 3.

16. The direct carbon fuel cell according to claim 6, wherein the anode is the anode according to claim 4.

17. The direct carbon fuel cell according to claim 6, wherein the anode is the anode according to claim 5.
